(19) United States
(12) Patent Application Publication
(10) Pub. No.: US 2026/0170774 A1
(43) Pub. Date: Jun. 18, 2026

(54) INSTRUCTION CREATION AND CONSUMPTION SYSTEM AND METHODS THEREOF FOR AUGMENTED AND MIXED REALITY SYSTEMS

(71) Applicant: ALEX S. GOLDBERG, SEATTLE, WA (US)

(72) Inventor: ALEX S. GOLDBERG, SEATTLE, WA (US)

(21) Appl. No.: 19/413,134

(22) Filed: Dec. 9, 2025

Related U.S. Application Data
(60) Provisional application No. 63/733,483, filed on Dec. 13, 2024.

(51) Int. Cl. G06T 19/00; G06T 7/60

(52) U.S. Cl. CPC G06T 19/006; G06T 7/60; G06T 2200/04; G06T 2207/30204; G06T 2219/004; G06T 2219/024

(57) ABSTRACT

With respect to some embodiments, disclosed herein are computerized methods for instruction creation and consumption systems for augmented and mixed reality systems, as well as a non-transitory computer-readable storage medium for carrying out technical operations of the computerized methods. The non-transitory computer-readable storage medium has tangibly stored thereon, or tangibly encoded thereon, computer-readable instructions that, when executed by one or more devices (e.g., one or more personal computers or servers), cause at least one processor to perform a method for instruction creation and consumption systems for augmented and mixed reality systems.

### CROSS-REFERENCE TO RELATED APPLICATIONS

The present application claims the benefit of priority from U.S. Provisional Patent Application No. 63/733,483, filed on Dec. 13, 2024, and entitled “INSTRUCTION CREATION AND CONSUMPTION SYSTEM AND METHODS THEREOF”, the entire disclosure of which application is hereby incorporated herein by reference.

### TECHNICAL FIELD

The present disclosure relates to instruction creation and consumption systems for augmented and mixed reality systems.

### BACKGROUND

Augmented reality (AR) and mixed reality (MR) systems overlay digital information onto real-world environments via AR or MR devices. However, such systems are limited by several technical challenges. For example, known systems may lack mechanisms for anchoring content to physical locations or objects virtually, resulting in misalignment and inconsistent user experiences. Many AR and MR systems also do not support intuitive creation of multi-step, spatially-accurate instruction sets by non-technical users or automated systems. Additional limitations include insufficient support for sharing, editing, or consuming instructions for such systems, as well as limited capabilities for capturing user feedback. Accordingly, there remains a need for improved computing systems and methods that provide reliable creation, sharing, and consumption of AR or MR applications and instructions, including systems that provide consistent spatial alignment and support multi-step workflows effectively.

### SUMMARY

Disclosed herein are technologies to create instructions in or for augmented reality or mixed reality and consume instructions in augmented reality or mixed reality. The computing systems and technologies disclosed herein can also provide specific technical solutions to at least overcome the technical problems mentioned in the background section and other parts of the application as well as other technical problems not described herein but recognized by those skilled in the art related to augmented reality or mixed reality systems.

With respect to some embodiments, disclosed herein are computerized methods for instruction creation and consumption systems for augmented and mixed reality systems, as well as a non-transitory computer-readable storage medium for carrying out technical operations of the computerized methods. The non-transitory computer-readable storage medium has tangibly stored thereon, or tangibly encoded thereon, computer-readable instructions that, when executed by one or more devices (e.g., one or more personal computers or servers), cause at least one processor to perform a method for instruction creation and consumption systems for augmented and mixed reality systems.

Some embodiments can include a system (such as a computing system or software platform) or methods thereof for creating, sharing, and consuming instructions for or in augmented reality (AR) or mixed reality (MR). The system supports various modes, such as a creator path and a consumer path. Creators can be a human creator or an artificial intelligence creator (or AI creator) or actor, and can generate instruction sets including multiple instruction steps. Each instruction step can include digital assets placed in a virtual 3D world space. The assets can include prefabricated assets (e.g., directional icons, timers, signs, etc.) or custom assets (e.g., prefabricated images, audio, video, 3D models, etc.). Such embodiments and others can include parts for uploading or generating assets.

In some examples, each instruction step is anchored to a virtual-world-space marker, or VWS marker. A VWS marker can include an image marker (e.g., QR code, logo, unique 2D pattern, etc.) or an object marker (e.g., scanned 3D object or spatial anchor). VWS markers can provide alignment between a virtual world space of a creator or a consumer. In some cases, the virtual assets appear in a selected physical location as a virtualization in that location. Also, similar to the creator, the consumer can be a human or an AI actor. In some embodiments, consumers scan these markers to invoke the instruction sets in AR or MR, follow the steps, and provide feedback, including alternative steps or annotations. Also, consumers can selectively enable or disable feedback.

In some examples, both the creator and consumer workflows involve multi-step logic flows with scanning for existing instructions, verifying accuracy, previewing, editing, publishing, and saving assets and creations. In some cases, the system supports execution on various computing devices, including AR glasses, VR headsets, mobile devices, and cloud-based systems. Furthermore, AI or machine learning (ML) systems can automatically create instruction sets based on training from videos or printed instructional materials.

These and other important aspects of the invention are described more fully in the detailed description below. The invention is not limited to the particular assemblies, apparatuses, methods, and systems disclosed herein. Other embodiments can be used and changes to the described embodiments can be made without departing from the scope of the claims that follow the detailed description.

### BRIEF DESCRIPTION OF THE DRAWINGS

The present disclosure can be understood more fully from the detailed description given below and from the accompanying drawings of various example embodiments of the disclosure.

FIGS. 1 to 5, 9, and 10 illustrate example methods of the technologies disclosed herein, in accordance with some embodiments of the present disclosure.

FIG. 6 illustrates a block diagram of example aspects of an example computing system, in accordance with some embodiments of the present disclosure.

FIG. 7 illustrates example computer-executable instructions of the computing system of FIG. 6 that are configured to provide at least some of the steps of the methods described herein, as well as implement at least some of the system modules and models described herein, in accordance with some embodiments of the present disclosure.

FIG. 8 illustrates an example computer network to implement technologies disclosed herein, in accordance with some embodiments of the present disclosure.

### DETAILED DESCRIPTION

The present disclosure can be understood more fully from the detailed description given below and from the accompanying drawings of various example embodiments of the disclosure.

Disclosed herein are technologies to create instructions for or in augmented reality (AR) or mixed reality (MR) and consume instructions in AR or MR. The computing systems and technologies disclosed herein can also provide specific technical solutions to at least overcome the technical problems mentioned in the background section and other parts of the application as well as other technical problems not described herein but recognized by those skilled in the art related to AR or MR.

With respect to some embodiments, disclosed herein are computerized methods for instruction creation and consumption systems for augmented and mixed reality systems, as well as a non-transitory computer-readable storage medium for carrying out technical operations of the computerized methods. The non-transitory computer-readable storage medium has tangibly stored thereon, or tangibly encoded thereon, computer-readable instructions that, when executed by one or more devices (e.g., one or more personal computers or servers), cause at least one processor to perform a method for instruction creation and consumption systems for AR or MR.

The innovation being disclosed can include an application or software that can be used with head-worn displays, such as augmented reality headsets, goggles, glasses, or eyewear, or virtual reality headsets or goggles, as well as handheld mobile computing devices such as phones or tablets. The innovation provides a way to easily create instructions for anything and then enable any individual or entity to consume instructions at high fidelity. It also provides a means for creating community sharing instructions, and iterating on such instructions. Enterprises can enhance communication to their end consumers with embedded image markers or object anchors that invoke instruction sets to provide instructions to their consumer base in a new fashion. “Influencers”, Internet celebrities, and anyone who might have previously created instructional video content to online video platforms (e.g., YouTube, Vimeo, etc.) can be empowered to leverage that content in an AR or MR solution through the innovation described herein.

In some embodiments, such as shown by the methods 100 and 200, there can be two paths of operation, a creator path and a consumer path, respectively. The creator path includes creators that create instruction sets. The creator can be a human creator or an artificial intelligence creator. An AI creator can operate or create based on training or a trained model, such as through machine learning, on inputs including videos (such as video tutorials) and printed instructional material. For example, AI-based creators can be trained via video content and 2D printed material that is used as input for training models. And, the content of AI-based creators can occur according to such video content and printed material used as the inputs for the training.

Instruction sets include at least one instruction step. Creators build an instruction step by way of at least digital asset placement and prefabricated assets. Digital asset placement can include placing instructional assets in a virtual world space of a creator, and such assets can provide information specific to an instruction step. Instructional assets, which can be prefabricated assets, include world space assets that include, in extended reality (XR) technology.

A virtual world space is a 3D space where users position, rotate, and scale virtual objects. Prefabricated assets can be available to all users of the system through such spaces. Examples of prefabricated assets include directional icons (e.g., up or down arrows, rotate arrows, such as including any specific direction, turn or sideways arrows, such as any specific direction or angle, etc.). Examples of such assets can also include miscellaneous step icons that can include icons for unboxing, cleaning, waiting a duration of time, a customizable timer that a creator can set to any time duration, drying, applying a substance, placing an object out of direct sunlight, etc. Also, examples of prefabricated assets include signs. Signs are different than icons in that they are 2D panes that float in the spaces, and with an embedded text editor the creator can create messaging to be displayed on the sign.

In some embodiments, custom assets are created on the native device on which the creator is creating the instruction step, or have been downloaded from a companion application or website, and are unique to each user.

The system supports many different types of customized assets that can be added to an instruction set. In some embodiments, creators can add custom audio content to the instruction step that can be automatically invoked when the step is launched. The system can support common audio file formats (e.g., .wav, .mp3, etc.). The creator can set the audio to play or not play automatically, and loop. The end user (e.g., consumer) can stop or start the audio clip during the step. In some embodiments, examples of audio clips are narration for the step or background music for the step. In some embodiments, creators can add custom video content to the instruction step that can be automatically invoked when the step is launched. The system can support common video file formats (e.g., .mov, .mP4, etc.). The creator can set the video to play or not play automatically, and loop. The end user (e.g., consumer) can stop or start the video during the step. In some embodiments, creators can add images to the steps. The system can support common image file formats (e.g., .png, .jpg, etc.). Example images can include informative infographics specific to the step. In some embodiments, creators can add 3D models to the instruction step. The system can support common 3D file formats (e.g., .obj, .glb, .fbx).

In some embodiments, after assets are in place for a step, the creator can place a marker in the space that can be used to synchronize the location of assets in the space. This is a location that can provide for the consumer to link off of in order for the assets to appear in their expected location for a corresponding instruction step. Examples of virtual-world-space markers or VWS markers can include unique 2D images that exist in both the creator's world space and the consumer's world space such as a QR code on an object, a logo, unique icon on the object, or other unique 2D images, and then the step's assets can appear as expected predicated on the 2D image that is recognized.

In some embodiments, a three-dimensional object in the creator's space can be scanned by the creator, then the consumer can scan that object in its space, and the step's assets can appear as expected, predicated on the object that is recognized. In some embodiments, an object marker includes a unique geometry in a physical space. Also, the object marker can be or include a spatial anchor (e.g., in which the spatial anchor is or includes an object or image marker).

A consumer path can include how consumers consume instruction sets. A step setup can include how consumers can set up the step by way of syncing their world space with the VWS marker. An image marker setup can include how a consumer can scan a specific image in their world space to invoke the step's assets to appear in its world space. An object marker setup can include how a consumer can scan a specific object in its world space to invoke the step's assets to appear in their world space. Step feedback can include how consumers can make recommendations to the instruction steps, including alternative instruction steps. Other consumers can activate or deactivate consumer feedback from appearing in their instruction steps. Examples of consumer feedback can include suggestions or annotations to the set of instructions or to a specific instruction step. If a consumer invokes an alternative step, they can have access to the creator feature set for step creation to create a proposed alternate step.

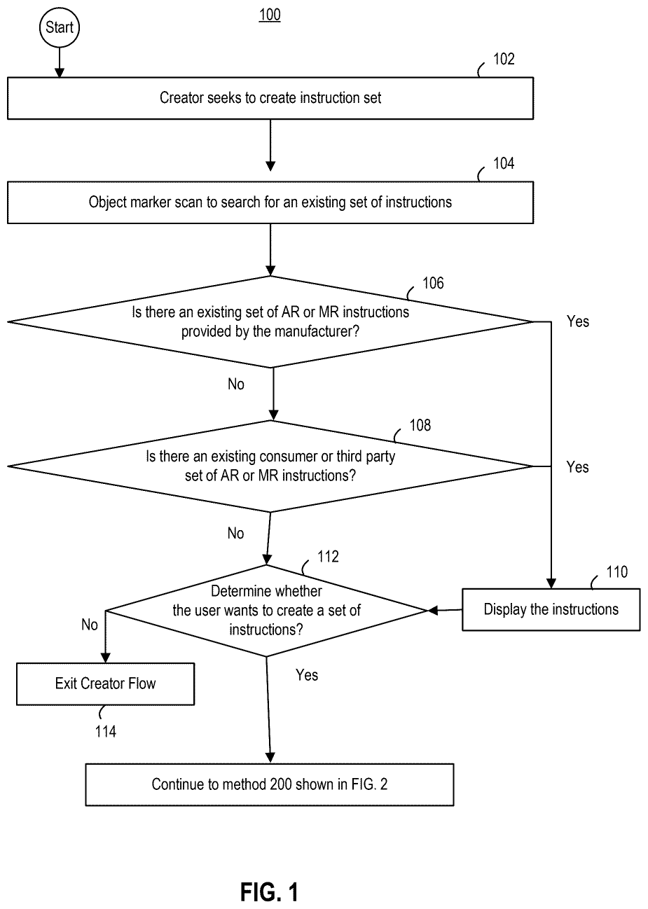

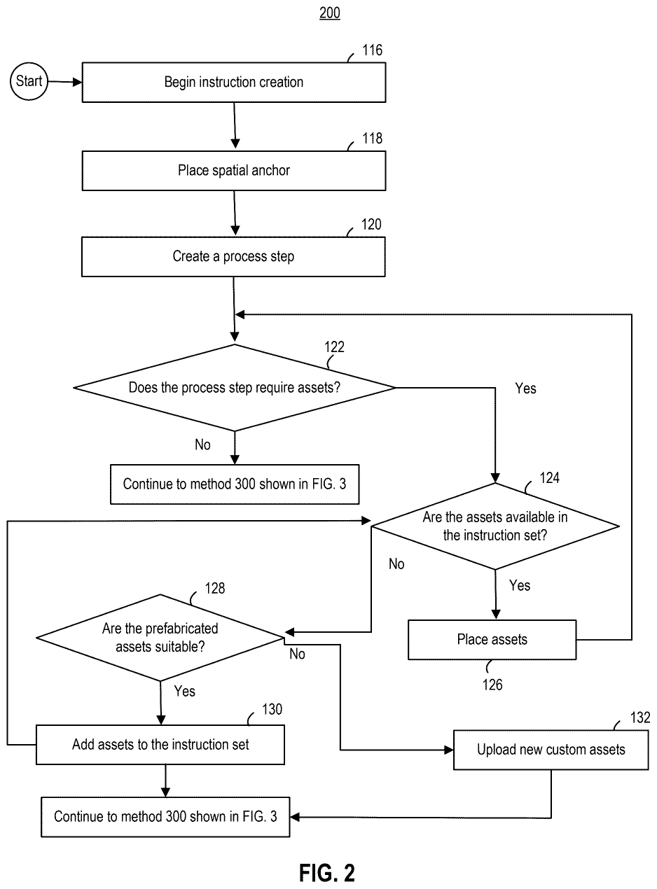

FIGS. 1 to 3 show methods 100 to 300, which show example steps of a creator path. All the steps of the methods 100 to 300 can be performed by a computing system or a user interface of such a system. Method 100 starts with the creator seeking to create an instruction set via a computing system or a user interface thereof, at step 102. The method then continues, at step 104, with an object marker of the system scanning to search for an existing set of instructions. Then, at step 106, it continues with determining whether there is an existing set of AR or MR instructions provided by the manufacturer. If the answer is no to step 106, then the method continues, at step 108, with determining if there is an existing consumer or third-party set of AR or MR instructions. If yes at step 106, then the method continues, at step 110, with displaying the instructions, such as via a UI of the system. The same occurs after step 108 if there is an existing consumer or third-party set of AR or MR instructions. Otherwise, at step 112, the method continues with determining whether the user wants to create a set of instructions. If the user does want to create a set of instructions through the UI or the system, then the method 100 continues with method 200 shown in FIG. 2. Otherwise, the method continues with exiting the creator path at step 114. In some embodiments, step 112 is not dependent on whether or not there is an existing consumer or third-party set of AR or MR instructions, and step 112 or the determining whether the user wants to create a set of instructions can occur before step 108, after step 108, or when step 108 occurs.

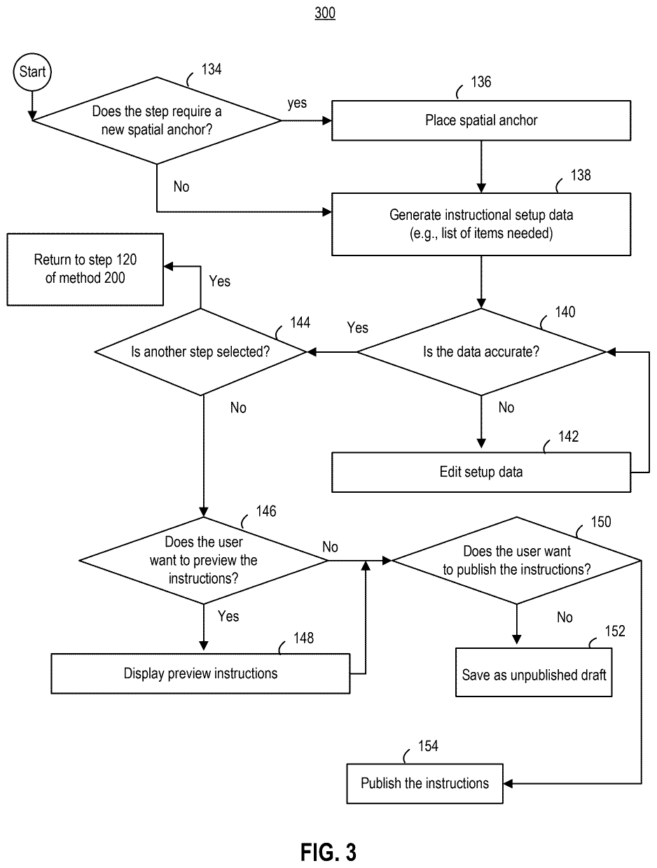

Method 200 starts with the system beginning the instruction creation at step 116. Then, at step 118, the method continues with placing a spatial anchor in the instructions or associating the anchor with the instructions. At step 120, the method continues with creating a process step for the instructions. At step 122, the system determines whether the process step requires assets. If it does require assets, at step 124, the system determines whether the assets are available in or to the instruction set. If the assets are available, then the system places the assets in the instructions or associates them with the instructions (at step 126). Otherwise, if the process step does not require assets, then the method continues on to method 300 shown in FIG. 3. When the assets are not available (at step 124), the method continues with determining whether they are suitable—at step 128. If they are suitable, then the assets are added to the instruction set (at step 130), and the method 200 continues to method 300 shown in FIG. 3. Otherwise, the method continues with uploading new custom assets or providing a method for uploading such assets—at step 132.

Method 300 starts with the system determining if the process step requires a new spatial anchor (at step 134). If it does, then the spatial anchor is placed (at step 136). Otherwise, at step 138, the system generates instructional setup data (e.g., a list of items needed for the instructions). Either way, if the placement of the spatial anchor occurs, then it is followed by the data generation (at step 138). Next, the method 300 continues with determining if the data is accurate (at step 140). If it is not accurate, then it can be edited (at step 142), and the accuracy can be redetermined. Once the data is determined to be accurate at step 140, then, at step 144, the system can determine if another step is selected or preferred. If another process step is selected or preferred, then the method returns to step 120 of the method 200. Otherwise, at step 146, the method continues with determining whether the user wants to preview the instructions or not. If yes, then the instructions are displayed by a UI of the system (at step 148). Either way, at step 150, the method continues with determining whether the user wants to publish the instructions. If not, at step 152, the system can save the unpublished instructions. Otherwise, the instructions are published by the system (at step 154).

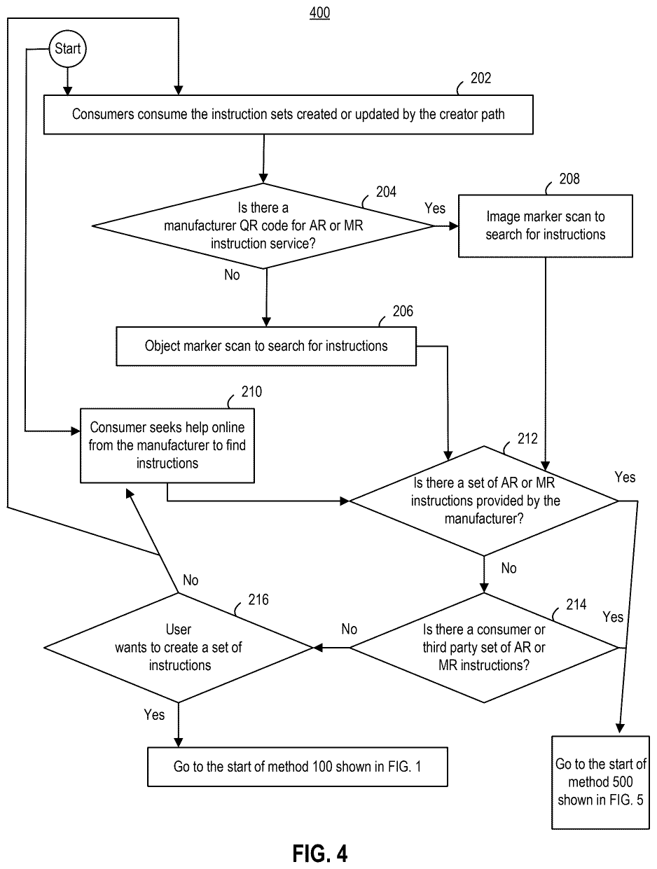

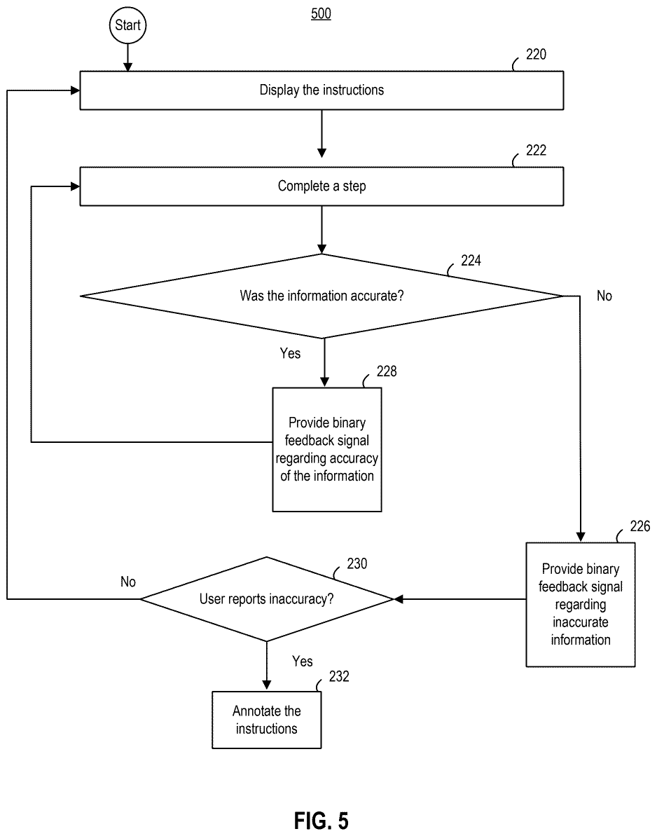

FIGS. 4 and 5 show methods 400 and 500, which show example steps of a consumer path. All the steps of the methods 400 to 500 can be performed by a computing system or a user interface of such a system. Method 400 starts with the system operating with the consumers consuming the instruction sets created or updated by the creator path (at step 202). At step 204, the method continues with the system determining if there is a manufacturer QR code for AR or MR instruction services. If not, the system runs the object marker scan to search for instructions (at step 206). If the code exists, the system runs the image marker scan for instructions (at step 208). Also, at step 210, the system can operate with the consumer so the consumer can seek help online from the manufacturer to find instructions. Either way, at step 212, the method continues with determining whether there is a set of AR or MR instructions provided by the manufacturer. At step 214, the method continues with determining whether there is a consumer or third-party set of AR or MR instructions. And, at step 216, the system provides for the user to select to create a set of instructions. If the user selects to create a set of instructions, then operations return to method 100 shown in FIG. 1. Otherwise, if there are instructions provided by the manufacturer (at step 212) or the consumer or a third party (at step 214), then the operations continue with method 500 shown in FIG. 5.

Method 500, shown in FIG. 5, starts with displaying the instructions after their generation or selection in method 400 or beforehand (at step 220). Also, in method 500, the system completes at least one step of the instructions (at step 222). At step 224, the system determines whether the data or information of the instructions is accurate. If the data or information is inaccurate, then at step 226, the system provides a binary feedback signal corresponding to the discovery. Also, if the data or information is accurate, a corresponding binary feedback signal is provided by the system (at step 228). If the data or information is accurate, then the method returns to step 222, in which the method includes completing another step of the instructions. At step 230, the method continues with a user being provided the capability to report the inaccuracy. If the user does not follow through with the reporting, the method can return to step 220 (which includes displaying the instructions). Otherwise, at step 232, the system annotates the instructions according to the inaccuracies discovered.

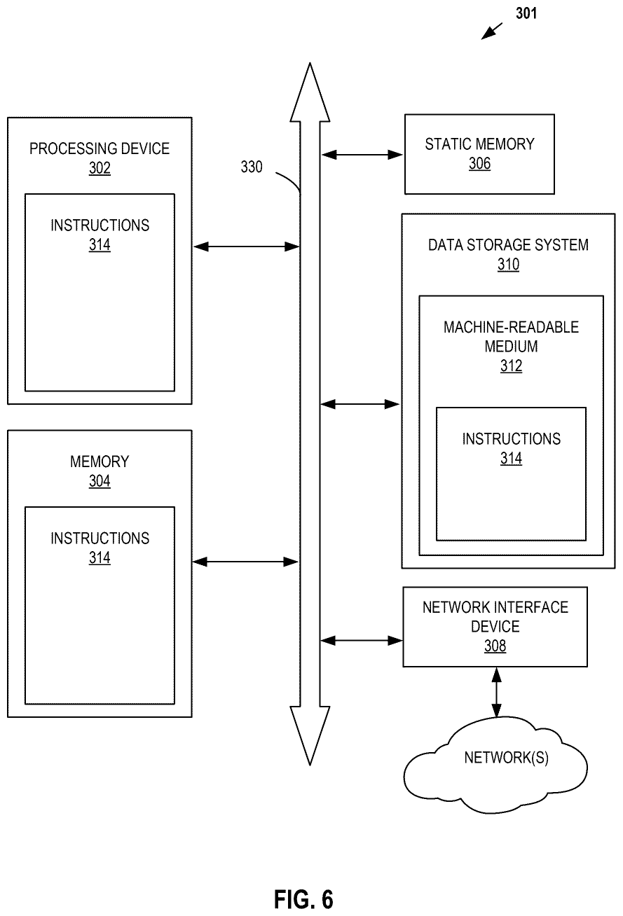

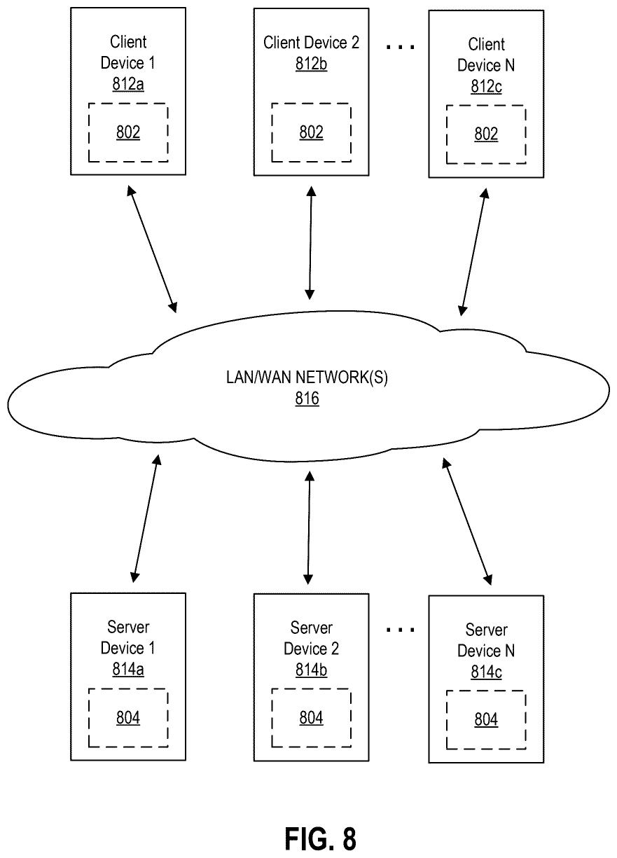

FIG. 6 illustrates a block diagram of example aspects of an example computing system 301, in accordance with some embodiments of the present disclosure. FIG. 3 illustrates parts of the computing system 301 within which a set of instructions, for causing a machine of the computing system 301 to perform any one or more of the methodologies discussed herein, can be executed (such as any one or more of the methods found in FIGS. 1 to 5). In some embodiments, the computing system 301 can correspond to a host system that includes, is coupled to, or utilizes memory or can be used to perform the operations of a controller (e.g., to execute an operating system to perform operations corresponding to any one of the client or server devices shown in FIG. 8). In alternative embodiments, the machine can be connected (e.g., networked) to other machines in a LAN, an intranet, an extranet, or the Internet. The machine can operate in the capacity of a server or a client machine in a client-server network environment, as a peer machine in a peer-to-peer (or distributed) network environment, or as a server or a client machine in a cloud computing infrastructure or environment. In some embodiments, where a cloud computing infrastructure is used, the infrastructure utilizes an on-demand cloud computing platform and APIs, such as AWS.

The machine can be a personal computer (PC), a tablet PC, a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein (such as any one or more of the methods or operations found in FIGS. 1 to 5).

The computing system 301 includes a processing device 302, a main memory 304 (e.g., read-only memory (ROM), flash memory, dynamic random-access memory (DRAM), etc.), a static memory 306 (e.g., flash memory, static random-access memory (SRAM), etc.), and a data storage system 310, which communicate with each other via a bus 330. The processing device 302 represents one or more general-purpose processing devices such as a microprocessor, a central processing unit, or the like. More particularly, the processing device can be a microprocessor or a processor implementing other instruction sets, or processors implementing a combination of instruction sets. The processing device 302 can also be one or more special-purpose processing devices such as an application specific integrated circuit (ASIC), a field programmable gate array (FPGA), a digital signal processor (DSP), a network processor, or the like. The processing device 302 is configured to execute instructions 314 for performing the operations discussed herein. The computing system 301 can further include a network interface device 308 to communicate over the LAN/WAN network(s). The data storage system 310 can include a machine-readable storage medium 312 (also known as a computer-readable medium) on which is stored one or more sets of instructions 314 or software embodying any one or more of the methodologies or functions disclosed herein (such as any one or more of the methods or corresponding operations found in FIGS. 1 to 5). The instructions 314 can also reside, completely or at least partially, within the main memory 304 or within the processing device 302 during execution thereof by the computing system 301, the main memory 304 and the processing device 302 also constituting machine-readable storage media.

While the machine-readable storage medium 312 is shown in an example embodiment to be a single medium, the term “machine-readable storage medium” should be taken to include a single medium or multiple media that store one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In some embodiments, the instructions 314 include instructions to implement functionality corresponding to artificial intelligence (AI) or machine learning disclosed herein (which in some embodiments, can enhance the computerized decision making and determinations described herein). For the purposes of this disclosure, artificial intelligence includes any form of intelligence implemented by a machine, such as a computing system (e.g., see computing system 301). In some embodiments, AI disclosed herein includes machine learning. In some embodiments, AI disclosed herein includes search and mathematical optimization, formal logic, artificial neural networks (ANNs), methods based on statistics or probability, or any combination thereof. In some embodiments, machine learning disclosed herein includes supervised learning or unsupervised learning.

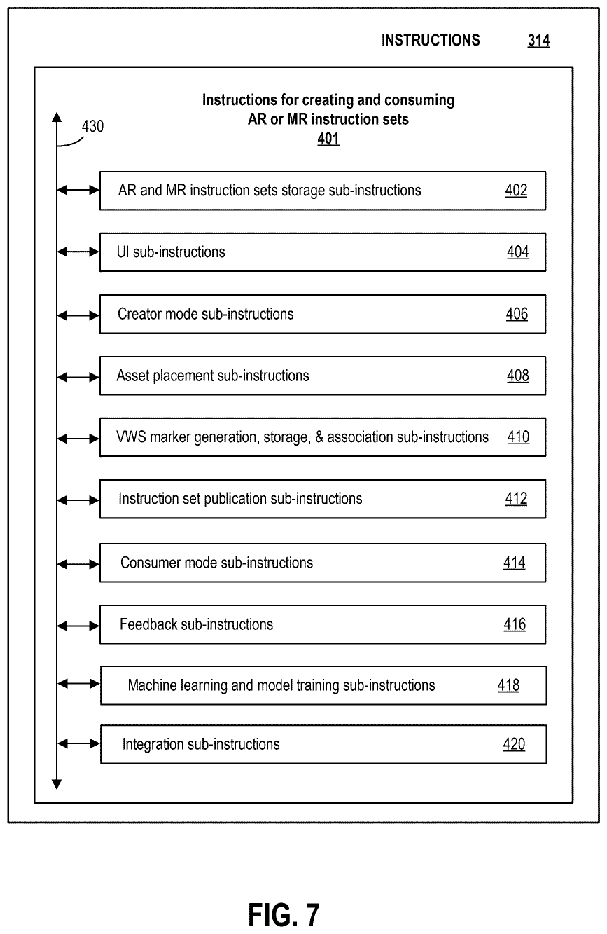

FIG. 7 illustrates example computer-executable instructions 314 and 401 that are configured to provide some of the operations and the steps of the methods described herein, in accordance with some embodiments of the present disclosure. As depicted, instructions 401 are sub-instructions of instructions 314 and are configured for creating and consuming AR or MR instruction sets. In other words, instructions 314 include instructions 401 and also provide logic for creating and consuming AR or MR instruction sets and corresponding information, data, and data structures. Also, as depicted, sub-instructions 402 to 420 are sub-instructions of instructions 401. In other words, instructions 401 include sub-instructions 402 to 420. Like instructions 314, processing device 302 is configured to execute instructions 401 and its sub-instructions 402 to 420 for performing operations discussed herein (e.g., see any one or more of the steps of methods 100 to 500 and methods 900 and 1000). The instructions 401 can reside, completely or at least partially, within the main memory 304 or within the processing device 302 during execution thereof by the computing system 301 or the processing device. And, in some embodiments, the instructions 401 include instructions to implement functionality corresponding to the client devices and server devices shown in FIG. 8 (e.g., see system frontend 802 and system backend 804 shown in FIG. 8). As shown, the instructions 401 include sub-instructions 402 to 420, which can interact with each other through a communications bus 430. The bus 430 can be implemented via computer hardware or software.

Instructions 401 include AR and MR instruction sets storage sub-instructions 402 configured to store instruction sets created for and consumed in AR or MR. The storage sub-instructions 402 are also configured to organize the steps, assets, and other information and data associated with the instruction sets. The storage sub-instructions 402 can interact or include a structured data module that can be part of or operate with a relational database or relational database management system.

Instructions 401 also include user interface (UI) sub-instructions 404 that are configured to provide user interfaces and applications for different operations described herein, and such user interfaces can be implemented or provided through head worn displays, such as augmented reality headsets, goggles, glasses or eyewear, or virtual reality headsets or goggles, as well as handheld mobile computing devices such as phones or tablets, for example.

Instructions 401 also include creator mode sub-instructions 406 that are configured to provide a creator mode that provides for a creator to generate an instruction set including instruction steps. The creator is either a human or an artificial intelligence (AI). Instructions 401 also include asset placement sub-instructions 408 that are configured to, for each instruction step, facilitate the placement of digital assets in a virtual world space of the creator. The digital assets can include audio files, video files, images, 3D objects, or a combination thereof. Instructions 401 also include VWS marker generation, storage, & association sub-instructions 410 that are configured to associate each instruction step with a VWS marker. The VWS marker can include an image marker, an object marker, or a combination thereof, and the VWS marker can define positional alignment for the digital assets. Instructions 401 also include instruction set publication sub-instructions 412 that are configured to publish the instruction set to a shared service. Instructions 401 also include consumer mode sub-instructions 414 that are configured to provide a consumer mode allowing a consumer to scan a virtual-world-space marker to synchronize a virtual world space of a consumer with a virtual world space of the creator. The consumer can be either a human or an AI agent or actor. And, instructions 401 further include feedback sub-instructions 416 that are configured to receive consumer feedback through annotations or alternative instruction steps and store the feedback for selective display to other consumers (such as via execution of sub-instructions 402).

Instructions 401 also include machine learning and model training sub-instructions 418 that are configured to implement any of the machine learning or model training described herein, as well as related features thereof, and implement any corresponding operations found in the systems and methods described herein. Instructions 401 also include integration sub-instructions 420 that are configured to implement any of the features for integrating the computing system with a third-party system or with online applications and properties, as well as implement any corresponding operations found in the methods described herein. Integration sub-instructions 420 can be configured to implement any of the features for integrating the computing system with a generative artificial intelligence chatbot, a derivative thereof, or generative models. For example, the user interface, or at least some of the interfaces, can interact with or use a generative artificial intelligence chatbot, a derivative thereof, or generative models to produce text, images, videos, or other forms of data. The models, or the chatbot, which can also be at least partially implemented or provided through instructions 420, can learn the underlying patterns and structures of their training data and use them to produce new data based on the input, such as through the use of machine learning and model training sub-instructions 418, which occur through natural language prompts such as a generative artificial intelligence chatbot.

Some embodiments include a system, including: a processor; and a non-transitory machine-readable medium storing instructions for creating and consuming augmented-reality (AR) or mixed-reality (MR) instruction sets (e.g., see instructions 401), and for storing such instruction sets (e.g., see sub-instructions 402) and for corresponding user interfaces (e.g., see sub-instructions 404). When the instructions, such as instructions 401, are executed, the processor or the system provides a creator mode (such as through execution of creator mode sub-instructions 406), providing for a creator to generate an instruction set including instruction steps, wherein the creator is either a human or AI. Also, when the instructions are executed, the processor or the system, for each instruction step, facilitates placement of digital assets (such as through execution of asset placement sub-instructions 408) in a virtual world space of the creator, wherein the digital assets include audio files, video files, images, 3D objects, or a combination thereof. Also, when the instructions are executed, the processor or the system associates each instruction step with a virtual-world-space marker (such as through execution of VWS marker generation, storage, and association sub-instructions 410), wherein the virtual-world-space marker includes an image marker, an object marker, or a combination thereof, and wherein the virtual-world-space marker defines positional alignment for the digital assets. Also, when the instructions are executed, the processor or the system publishes the instruction set to a shared service (such as through execution of instruction set publication sub-instructions 412).

Additionally, when the instructions are executed, the processor or the system provides a consumer mode (such as through execution of consumer mode sub-instructions 414), providing for a consumer to scan a virtual-world-space marker to synchronize a virtual world space of a consumer with a virtual world space of the creator, wherein the consumer is either a human or AI. Also, when the instructions are executed, the processor or the system displays, via an AR or MR device, the instruction steps with associated digital assets in AR or MR (such as through execution of UI sub-instructions 404). Furthermore, when the instructions are executed, the processor or the system receives consumer feedback through including annotations or alternative instruction steps and store the feedback for selective display to other consumers (such as through execution of feedback sub-instructions 416).

In some examples, the instruction set generated in the creator mode is generated based on a trained creator model. Also, the trained creator model can be trained via machine learning (such as through execution of machine learning and model training sub-instructions 418). Further, in some examples, the machine learning includes logic executed by the processor or a second processor of the system to: generate the instruction steps; select or generate digital assets for each instruction step; assign a virtual-world-space marker for each instruction step; and output parts of the instruction set compatible with a consumer path. In some embodiments, aspects of the consumer path are linked to aspects of the instruction set and its instruction steps as a part of the synchronization of the virtual world space of the consumer with the virtual world space of the creator.

In some embodiments, the digital assets include directional icons, timers, and 2D signs with editable text. In some examples, digital assets are configured to auto-play or loop based on settings selected by the creator. Also, the virtual-world-space markers can include a QR code, and the instruction steps can include consumer annotations that trigger the display of alternative steps generated in creator mode. Further, syncing the consumer world space to the creator world space can include comparing geometric features of the scanned object marker to a stored 3D model. Also, the stored instructions for creating and consuming AR or mixed-reality MR instruction sets, when executed, can further cause the processors to synchronize the virtual world space of the consumer with the virtual world space of the creator by comparing features (such as geometric features) of the scanned virtual-world-space marker to a stored 3D model.

FIG. 8 illustrates an example computer network 800 to implement technologies disclosed herein, in accordance with some embodiments of the present disclosure. Some of the computing systems disclosed herein, as well as the network 800, include a system frontend 802 and a system backend 804. The computer network 800 can implement any of the methods, operations, modules, engines, models, or other types of components of the systems disclosed herein, such as via the frontend 802 or the backend 804. The computer network 800 is shown, including client devices (e.g., see client devices 812a, 812b, and 812c). As shown, the system frontend 802 can be hosted and executed on the client devices of the computer network 800. The computer network 800 is also shown, including server devices (e.g., see server devices 814a, 814b, and 814c). As shown, the system backend 804 can be hosted and executed on the server devices of the computer network 800.

Also, the computer network 800 is shown, including one or more LAN/WAN networks 816, which are shown communicatively coupling the server devices hosting the system backend 804 and the client devices hosting the system frontend 802. The LAN/WAN network(s) 816 can include one or more local area networks (LAN(s)) or one or more wide area networks (WAN(s)). The LAN/WAN network(s) 816 can include the Internet or any other type of interconnected communications network. The LAN/WAN network(s) 816 can also include a single computer network or a telecommunications network. More specifically, the LAN/WAN network(s) 816 can include a local area network (LAN) such as a private computer network that connects computers in small physical areas, a wide area network (WAN) to connect computers located in different geographical locations, or a metropolitan area network (MAN)—also known as a middle area network—to connect computers in a geographic area larger than that covered by a large LAN but smaller than the area covered by a WAN.

At least each shown component of the computer network 800 can be or include a computer system, which can include memory that can include media. The media can include or be volatile memory components, non-volatile memory components, or a combination of such. In general, each of the computer systems can include a host system that uses the memory. For example, the host system can write data to the memory and read data from the memory. The host system can be a computing device such as a desktop computer, laptop computer, network server, mobile device, or such computing device that includes a memory and a processing device. The host system can include or be coupled to the memory so that the host system can read data from or write data to the memory. The host system can be coupled to the memory via a physical host interface. The physical host interface can provide an interface for passing control, address, data, and other signals between the memory and the host system.

As mentioned, disclosed herein are computerized methods as well as a non-transitory computer-readable storage medium for carrying out technical operations of the computerized methods. The non-transitory computer-readable storage medium has tangibly stored thereon, or tangibly encoded thereon, computer-readable instructions that, when executed by one or more devices (e.g., one or more personal computers or servers), cause at least one processor to perform a method including methods for creating and consuming AR or MR instruction sets.

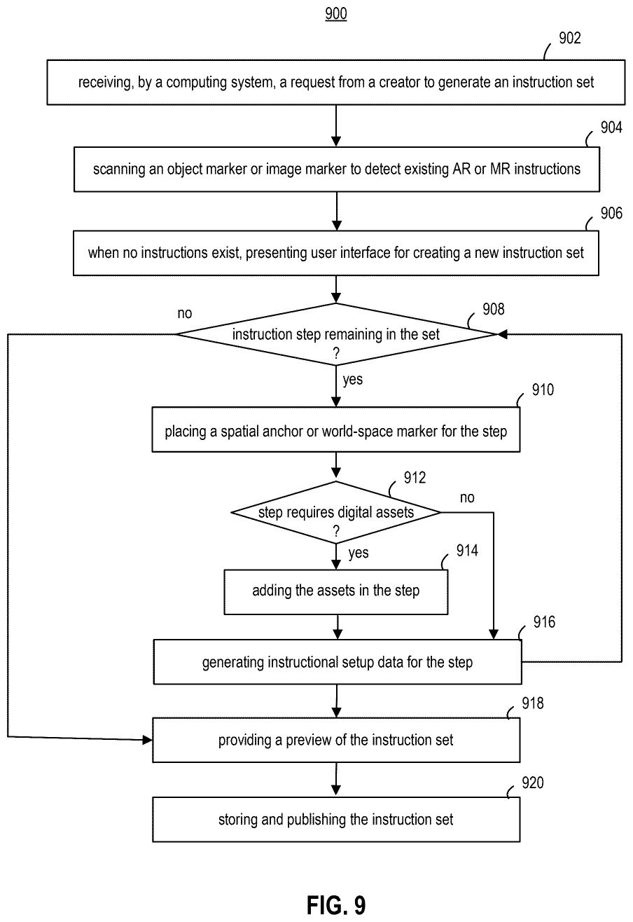

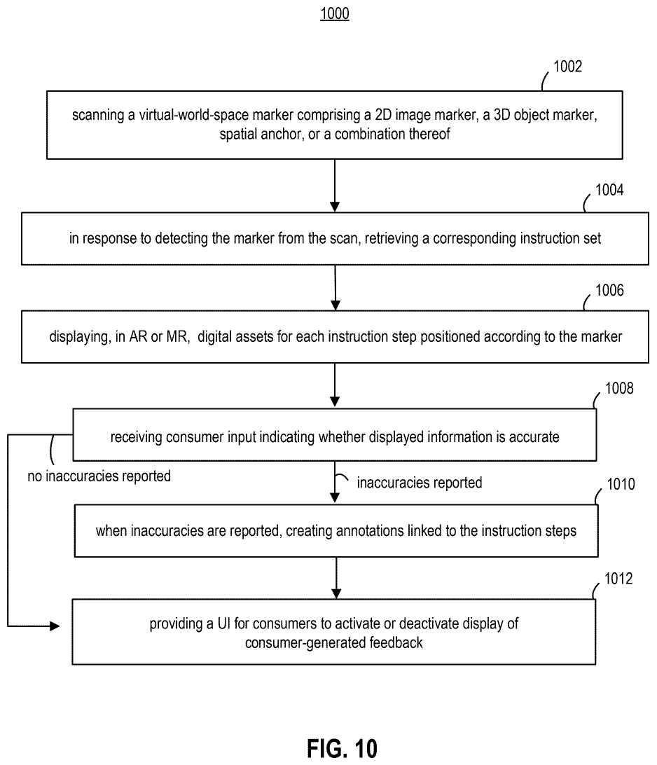

In addition to the computerized methods disclosed with respect to FIGS. 1 to 5, FIGS. 9 and 10 also disclose computerized methods. FIG. 9 shows computerized operations for creating AR or MR instruction sets, and FIG. 10 depicts computerized operations for consuming AR or MR instruction sets.

FIG. 9 illustrates method 900 that starts with receiving, by a computing system, a request from a creator to generate an instruction set (at step 902). Method 900 continues with scanning, by the computing system, an object marker or image marker to detect existing AR or MR instructions (at step 904). Also, method 900 includes, when no instructions exist, presenting, by the computing system, a user interface for creating a new instruction set (at step 906). The method 900 also includes, for each instruction step of the instruction set: determining if a step remains in the set to be processed (step 908), placing, by the computing system, a spatial anchor or world-space marker for the step (at step 910), determining, by the computing system, whether the step requires digital assets (at step 912), when the step requires assets, adding, by the computing system, assets to the step (at step 914), and generating, by the computing system, instructional setup data for the step (at step 916). The method 900 also includes providing, by the computing system, a preview of the instruction set (at step 918). And, the method 900 includes storing and publishing, by the computing system, the instruction set (at step 920).

In some embodiments, the methods 900 and 1000 are integrated. For example, the combined method can include detecting, via scanning, by the computing system, the spatial anchor or world-space marker (e.g., see step 1002 of method 1000 shown in FIG. 10), wherein, for instance, the anchor or marker includes a 2D image marker, a 3D object marker, a spatial anchor, or a combination thereof. Also, the method can include, in response to detecting the marker from the scan, retrieving, by the computing system, the instruction set (e.g., see step 1004). Further, the method can include displaying, via an AR or MR device, in AR or MR, by the computing system, digital assets for each instruction step positioned according to the marker (e.g., see step 1006). Also, the method can include receiving, by the computing system, consumer input indicating whether displayed information is accurate (e.g., see step 1008), wherein, for example, the consumer input includes input from either a human or AI. The method can also include, when inaccuracies are reported, creating, by the computing system, annotations linked to the instruction steps (e.g., see step 1010). And, the method can include providing, by the computing system, a user interface for consumers to activate or deactivate display of consumer-generated feedback (e.g., see step 1012).

FIG. 10 illustrates method 1000 that starts with scanning, by a computing system, a virtual-world-space marker including a 2D image marker, a 3D object marker, a spatial anchor, or a combination thereof (at step 1002). Method 1000 continues with, in response to detecting the marker from the scan, retrieving, by the computing system, a corresponding instruction set (at step 1004). Method 1000 also includes displaying, via an AR or MR device, in AR or MR, by the computing system, digital assets for each instruction step positioned according to the marker (at step 1006). Further, method 1000 includes receiving, by the computing system, consumer input indicating whether displayed information is accurate (at step 1008). Also, method 1000 includes, when inaccuracies are reported, creating, by the computing system, annotations linked to the instruction steps (at step 1010). And, method 1000 includes providing, by the computing system, a user interface for consumers to activate or deactivate display of consumer-generated feedback (at step 1012).

In some examples, the models described with respect to methods and operations described herein can include machine learning or deep learning features. In some examples, the models include an artificial neural network (ANN) or a convolution neural network (CNN) and can include pre-or post-processing steps with respect to the inputs or outputs of the ANN or the CNN. In some embodiments, some of the methods include using, by the computing system, historical information as input into a model to train the model, wherein the historical information includes recorded information on users interacting with the computing system. Such methods can also include recording, by a recording component of the computing system, information corresponding to a given user of the users interacting with the system. And, the methods can also include using, by the computing system, at least part of the recorded information as input into the trained model to generate an output of the trained model regarding the given user.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a predetermined result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and functionality presented herein are not inherently related to any particular computer or other apparatus. Various general-purpose systems can be used with programs in accordance with the teachings herein, or it can prove convenient to construct a more specialized apparatus to perform the methods disclosed herein. The structure for a variety of these systems can appear as set forth herein. In addition, the present disclosure is not described with reference to any particular programming language. It can be appreciated that a variety of programming languages can be used to implement the teachings of the disclosure as disclosed herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read-only memory (“ROM”), random access memory (“RAM”), magnetic disk storage media, optical storage media, flash memory components, etc.

In the foregoing specification, embodiments of the disclosure have been described with reference to specific example embodiments thereof. It can be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a processor; and
a non-transitory machine-readable medium storing instructions for creating and consuming augmented-reality or mixed-reality instruction sets, that, when executed, cause the processors to:
provide a creator mode providing for a creator to generate an instruction set comprising instruction steps, wherein the creator is either a human or artificial intelligence;
for each instruction step, facilitate placement of digital assets in a virtual world space of the creator, wherein the digital assets comprise audio files, video files, images, 3D objects, or a combination thereof;
associate each instruction step with a virtual-world-space marker, wherein the virtual-world-space marker comprises an image marker, an object marker, or a combination thereof, and wherein the virtual-world-space marker defines positional alignment for the digital assets;
publish the instruction set to a shared service;
provide a consumer mode providing for a consumer to scan a virtual-world-space marker to synchronize a virtual world space of a consumer with a virtual world space of the creator, wherein the consumer is either a human or artificial intelligence;
display, via an augmented-reality or mixed-reality device, the instruction steps with associated digital assets in augmented-reality or mixed-reality; and
receive consumer feedback through annotations or alternative instruction steps and store the feedback for selective display to other consumers.

2. The system of claim 1, wherein the instruction set generated in the creator mode is generated based on a trained creator model, wherein the trained creator model is trained via machine learning.

3. The system of claim 2, wherein the machine learning comprises logic executed by the processor or a second processor of the system to:
generate the instruction steps;
select or generate digital assets for each instruction step;
assign a virtual-world-space marker for each instruction step; and
output parts of the instruction set compatible with a consumer path.

4. The system of claim 3, wherein aspects of the consumer path are linked to aspects of the instruction set and its instruction steps as a part of the synchronization of the virtual world space of the consumer with the virtual world space of the creator.

5. The system of claim 1, wherein the digital assets comprise directional icons, timers, and 2D signs with editable text.

6. The system of claim 1, wherein digital assets are configured to auto-play or loop based on settings selected by the creator.

7. The system of claim 1, wherein the virtual-world-space markers comprise a QR code.

8. The system of claim 1, wherein the instruction steps comprise consumer annotations that trigger display of alternative steps generated in creator mode.

9. The system of claim 1, wherein syncing the world space of the consumer to the world space of the creator includes comparing geometric features of the marker to a stored 3D model.

10. The system of claim 1, wherein the stored instructions for creating and consuming augmented-reality or mixed-reality instruction sets, when executed, further cause the processors to synchronize the virtual world space of the consumer with the virtual world space of the creator by comparing features (such as geometric features) of the virtual-world-space marker to a stored 3D model.

11. A method, comprising:
receiving, by a computing system, a request from a creator to generate an instruction set;
scanning, by the computing system, an object marker or image marker to detect existing AR or MR instructions;
when no instructions exist, presenting, by the computing system, a user interface for creating a new instruction set;
for each instruction step of the instruction set:
placing, by the computing system, a spatial anchor or world-space marker for the step;
determining, by the computing system, whether the step requires digital assets;
when the step requires assets, adding, by the computing system, assets to the step; and
generating, by the computing system, instructional setup data for the step;
providing, by the computing system, a preview of the instruction set; and
storing and publishing, by the computing system, the instruction set.

12. The method of claim 11, further comprising detecting, via scanning, by the computing system, the spatial anchor or world-space marker, wherein the anchor or marker comprises a 2D image marker, a 3D object marker, a spatial anchor, or a combination thereof.

13. The method of claim 12, further comprising, in response to detecting the marker from the scan, retrieving, by the computing system, the instruction set.

14. The method of claim 13, further comprising displaying, via an augmented-reality or mixed-reality device, in augmented-reality or mixed-reality, by the computing system, digital assets for each instruction step positioned according to the marker.

15. The method of claim 14, further comprising receiving, by the computing system, consumer input indicating whether displayed information is accurate, wherein the consumer input comprises input from either a human or artificial intelligence.

16. The method of claim 15, further comprising, when inaccuracies are reported, creating, by the computing system, annotations linked to the instruction steps.

17. The method of claim 16, further comprising providing, by the computing system, a user interface for consumers to activate or deactivate display of consumer-generated feedback.

18. The method of claim 11, wherein the creation of the instruction set is at least partially based on a trained creator model, wherein the trained creator model is trained via machine learning.

19. The method of claim 18, wherein the machine learning and the method comprises:
generating the instruction steps;
selecting or generating digital assets for each instruction step;
assigning a virtual-world-space marker for each instruction step; and
outputting parts of the instruction set compatible with a consumer path.

20. A method, comprising:
scanning, by a computing system, a virtual-world-space marker comprising a 2D image marker, a 3D object marker, a spatial anchor, or a combination thereof;
in response to detecting the marker from the scan, retrieving, by the computing system, a corresponding instruction set;
displaying, via an AR or MR device, in AR or MR, by the computing system, digital assets for each instruction step positioned according to the marker;
receiving, by the computing system, consumer input indicating whether displayed information is accurate;
when inaccuracies are reported, creating, by the computing system, annotations linked to the instruction steps; and
providing, by the computing system, a user interface for consumers to activate or deactivate display of consumer-generated feedback.
